(19) United States
(12) Patent Application Publication
(10) Pub. No.: US 2007/0254973 A1
(43) Pub. Date: Nov. 1, 2007

(54) Method for the Production of Polyurethane Foam Materials

(75) Inventors: Andreas Emge, Lemfoerde (DE); Elke Bleuel, Dresden (DE); Bernd Zaschke, Schoenfeld (DE); Holger Seifert, Bohmte (DE); Peter Von Malotki, Schwepnitz (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, Ludwigshafen (DE)

(21) Appl. No.: 11/547,259

(22) PCT Filed: Apr. 2, 2005
(86) PCT No.: PCT/EP05/03485

§ 371 Date: Oct. 4, 2006

(30) Foreign Application Priority Data
Apr. 5, 2004 (DE) 10 2004 017 294.3

(51) Int. Cl. C08G 18/40

(52) U.S. Cl. 521/170

(57) ABSTRACT

The invention relates to a process for producing polyurethane foams by reacting a) polyisocyanates with b) compounds having at least two hydrogen atoms which are reactive toward isocyanate groups in the presence of c) catalysts, d) blowing agents, e) if desired, auxiliaries and additives, wherein the compounds having at least two hydrogen atoms which are reactive toward isocyanate groups comprise at least one polar graft polyol.

The invention relates to a process for producing polyurethane foams, in particular rigid polyurethane foams, by reacting polyisocyanates with compounds having at least two hydrogen atoms which are reactive toward isocyanate groups, with the polyol component being made up partly of graft polyols or consisting entirely of graft polyols and being storage-stable.

Rigid polyurethane foams have been known for a long time and are used predominantly for insulation against heat and cold, e.g. in refrigeration appliances, in hot water storages, in district heating pipes or in building and construction, for example in sandwich elements. A summarizing overview of the production and use of rigid polyurethane foams may be found, for example, in the Kunststoff-Handbuch, Volume 7, Polyurethane, 1st edition 1966, edited by Dr. R. Vieweg and Dr. A. Hochtlen, 2nd edition 1983, edited by Dr. Guinter Oertel, and 3rd edition 1993, edited by Dr. Guinter Oertel, Carl Hanser Verlag, Munich, Vienna.

In the industrial production of rigid polyurethane foams, in particular those of sandwich elements, or in the production of refrigeration appliances, curing of the foams is of particular importance.

More rapid curing and the associated shortening of the demolding times increase the capacity of existing production lines without further investment in machinery and equipment being necessary. In the production of sandwich elements, more rapid curing allows a faster double-belt velocity and thus a higher output per unit of time.

A number of possible ways of reducing the demolding times are known from the prior art.

Thus, DE19630787 describes polyurethanes having improved curing as a result of the use of amine-containing polyols.

CA 2135352 describes polyurethanes having good demolding behavior as a result of use of a sucrose-initiated polyol.

According to JP 07082335, demolding is improved by use of a mixture of 1,3,5-tris(3-aminopropyl)hexahydro-s-triazine, pentamethyldiethylenetriamine and bis(2-dimethyl-aminoethyl)ether as catalysts.

According to JP 2001158815, good demolding is achieved by use of a mixture of aromatic polyester alcohols having a hydroxyl number in the range 405-500 mg KOH/g and a functionality of from 2 to 3 and polyether alcohols based on TDA and propylene oxide and/or butylene oxide and having a hydroxyl number of from 300 to 450 mg KOH/g and a functionality of from 3 to 4.

According to JP 10101762, good demolding is achieved by means of a sucrose-alkylene oxide polyol having a molar mass of greater than 300 and a functionality of greater than 3.

According to JP 02180916, good demolding is achieved by means of an aromatic polyesterol having a functionality of from 2.2 to 3.6 and a hydroxyl number of from 200 to 550 mg KOH/g and prepared by esterification of an aromatic polycarboxylic acid with diethylene glycol and a trifunctional alcohol.

Thus, both foams for use in refrigeration appliances and those for sandwich elements are typically produced using modified catalysis and/or using high-functionality or self-reactive amine-initiated polyols having a high hydroxyl number in order to achieve a high degree of crosslinking and thus more rapid curing.

The increased degree of crosslinking frequently impairs the flowability of the reaction mixture, so that a larger amount of material is necessary in order to fill a hollow space (e.g. a mold or a refrigerator housing).

It has been found that the at least partial use of polyols comprising polymers of olefinically unsaturated monomers, usually acrylonitrile and/or styrene, known as graft polyols, makes it possible to obtain foams which display good curing and demolding behavior combined with optimum flow behavior and also good mechanical properties, in particular good compressive strength. However, it has also been found that such polyol mixtures comprising graft polyols are less storage-stable.

It was an object of the invention to provide polyurethane foams, in particular closed-celled rigid polyurethane foams, based on a storage-stable polyol component which is made up partly of or consists entirely of graft polyols, which display good curing and demolding behavior combined with optimum flow behavior and also good mechanical properties, in particular good compressive strength.

For the purposes of the present invention, “storage-stable” means that the polyol components are stable for at least 2 weeks at 23° C. and no phase separation occurs.

This object has surprisingly been able to be achieved by the graft polyols used for producing the foams being polar. It has been found that polar graft polyols do not display phase separation.

For the purposes of the present invention, the term polar means that the graft polyol has a dielectric constant of at least 5.5 at 23° C. and 1000 Hz. The dielectric constant is determined in accordance with DIN 53483. The dielectric constant ε′ is determined from the measured capacity Cₐ (with specimen) and the capacity C₀ of the electrode arrangement in air (ε′=Cₐ/C₀).

The invention accordingly provides a process for producing polyurethane foams, in particular rigid polyurethane foams, which are preferably closed-celled, by reacting
a) polyisocyanates with
b) compounds having at least two hydrogen atoms which are reactive toward isocyanate groups in the presence of
c) catalysts,
d) blowing agents,
   wherein the compounds having at least two hydrogen atoms which are reactive toward isocyanate groups comprise at least one polar graft polyol.

As mentioned above, the polar graft polyol has a dielectric constant at 23° C. and 1000 Hz of at least 5.5.

The polarity of the graft polyols required according to the invention can be achieved, in particular, by at least one of the starting materials used for preparing them, in particular the carrier polyol or the macromer, being polar. Preference is given to both the carrier polyol and the macromer being polar.

For the purposes of the present invention, the carrier polyol is the polyol in which the in-situ polymerization of the olefinically unsaturated monomers is carried out. Polar carrier polyols have a dielectric constant in accordance with IEC 60250 of at least 7.5, preferably in the range from 8 to 20, at 23° C. and 1000 Hz.

For the purposes of the present invention, macromers are polymeric compounds which have at least one olefinically unsaturated group in the molecule and are added to the carrier polyol prior to the polymerization of the olefinically unsaturated monomers. More precise details regarding these compounds are given below. Polar macromers have a dielectric constant in accordance with DIN 53 483 of at least 6.0, preferably in the range from 7.5 to 12.0, at 23° C. and 1000 Hz.

The graft polyols used for the purposes of the invention can be used in an amount of up to 100% by weight. They are preferably used in an amount of from 0.5 to 70% by weight, in each case based on the component b).

In the production of refrigeration appliances, the graft polyols are preferably used in an amount of from 3% by weight to 70% by weight, particularly preferably from 3% by weight to 50% by weight, in particular in an amount of from 3% to 35% by weight, in each case based on the weight of the component b).

At an amount of less than 3% by weight, the effects due to the use of the graft polyols are barely perceptible.

In the production of sandwich elements, the graft polyols are preferably used in an amount of from 0.5 to 35% by weight, preferably from 0.5 to 25% by weight and in particular from 1 to 20% by weight, in each case based on the weight of the component b).

At a content of graft polyols of less than about 0.5% by weight, no improvement compared to conventional rigid polyurethane foams is found.

The graft polyols used in the process of the invention usually have a hydroxyl number in the range from 10 to 200 mg KOH/g. They can be prepared by customary and known methods.

The graft polyols used according to the invention, frequently also referred to as polymer polyols, are dispersions of polymers, usually acrylonitrile-styrene copolymers, in a polyether alcohol.

Graft polyols are usually prepared by free-radical polymerization of the olefinically unsaturated monomers, preferably acrylonitrile, styrene and also, if desired, further monomers, a macromer and a moderator using a free-radical initiator, usually azo or peroxide compounds, in a polyetherol or polyesterol, usually referred to as carrier polyol, as continuous phase.

Graft polyols are preferably prepared by in-situ polymerization of acrylonitrile, styrene or preferably mixtures of styrene and acrylonitrile, e.g. in a weight ratio of from 90:10 to 10:90, preferably from 70:30 to 30:70, using methods analogous to those described in the German patents 1111394, 1222669, 1152536 and 1152537.

Carrier polyols used are usually compounds having a functionality of at least from 2 to 8, preferably from 2 to 6, and a mean molecular weight M, of from 300 to 8000 g/mol, preferably from 500 to 7000 g/mol. The hydroxyl number of the polyhydroxyl compounds is generally from 20 to 800 and preferably from 23 to 190.

The graft polyols used in the process of the invention are, as indicated above, prepared using polar carrier polyols, i.e. polyols having a dielectric constant ε′ of at least 7.0 at 23° C. and 1000 Hz. This dielectric constant can usually be achieved in polyether alcohols by the carrier polyol having a content of ethylene oxide units of at least 30% by weight, based on the molecular weight of the polyol. In the case of polyester alcohols, this can be achieved by use of ethylene glycol or its higher homologs as alcohol component.

The graft polyols used in the process of the invention can, in one embodiment of the process of the invention, be prepared using carrier polyols having a functionality, hydroxyl number and molecular weight customary for producing rigid polyurethane foams but, as indicated, an increased proportion of EO which is untypical for rigid foam applications. Such polyether alcohols usually have a functionality of from 2 to 8, a hydroxyl number in the range from 100 to 800 mg KOH/g and a molecular weight M_{W} of from 200 to 2500. Starter substances used are polyfunctional alcohols such as glycerol, trimethylolpropane or sugar alcohols such as sorbitol, sucrose or glucose, aliphatic amines, such as ethylenediamine or aromatic amines such as toluenediamine (TDA), diphenylmethanediamine (MDA) or mixtures of MDA and polyphenylene-polymethylenepolyamines. As alkylene oxides, use is made of propylene oxide or mixtures of ethylene oxide and propylene oxide. Such graft polyols usually have a hydroxyl number in the range from 60 to 175 mg KOH/g at a solids content of from 35 to 60% by weight.

In one preferred embodiment of the process of the invention, carrier polyols which have the above-described dielectric constant, preferably as a result of an increased proportion of ethylene oxide units in the polyether chain, and in terms of their remaining properties correspond to customary and known flexible foam polyether alcohols are used. Such polyether alcohols usually have a functionality of from 2 to 8, a hydroxyl number in the range from 20 to 100 mg KOH/g and a molecular weight M, of from 2000 to 12 000. They are prepared by addition of propylene oxide or mixtures of ethylene oxide and propylene oxide onto H-functional starter substances, for example glycerol, trimethylolpropane or glycols such as ethylene glycol or propylene glycol. As catalysts for the addition reaction of the alkylene oxides, it is possible to use bases, preferably hydroxides of alkali metals, or multimetal cyanide complexes, known as DMC catalysts.

Preference is given to flexible foam polyethers having a proportion of ethylene oxide units in the polyether chain of >30% by weight, based on the molecular weight of the polyol. Such graft polyols usually have a hydroxyl number in the range from 10 to 75 mg KOH/g at a solids content of from 35 to 60%.

Carrier polyols according to the invention having the above-described dielectric constant can also be obtained in another way by incorporation of polar groups, e.g. polyols containing carbonate or acrylate groups.

It is also possible to use mixtures of at least two polyols, in particular at least two polyether alcohols, as carrier polyols. It is preferred that the mixture of the polyols is polar. It is entirely possible for nonpolar polyols to be present in the mixture. The desired polarity of the mixture used as carrier polyol can be set by blending of the polyols.

To ensure the stability of the graft polyols, compounds having ethylenically unsaturated groups, known as macromers, are, as indicated, added to the starting compounds before introduction of the unsaturated monomers. As indicated, the macromers likewise preferably have a dielectric constant ε′ in accordance with DIN 53 483 of greater than 6.0 at 23° C. and 1000 Hz.

The macromers, also referred to as stabilizers, are usually linear or branched polyetherols which have molecular weights M_{W} of >1000 g/mol and contain at least one usually terminal, reactive olefinically unsaturated group. The ethylenically unsaturated group can be inserted into an existing polyol by reaction with ethylenically unsaturated carboxylic acids and/or carboxylic anhydrides, e.g. maleic anhydride, fumaric acid, acrylate and methacrylate derivatives, or unsaturated isocyanate derivatives, e.g. 3-isopropenyl-1,1-dimethylbenzyl isocyanates, isocyanatoethyl methacrylates. Another way is preparation of a polyol by alkoxidation of propylene oxide and ethylene oxide using starter molecules having hydroxyl groups and an ethylenic unsaturation. Examples of such macromers are described in the patents U.S. Pat. No. 4,390,645, U.S. Pat. No. 5,364,906, EP 0 461 800, U.S. Pat. No. 4,997,857, U.S. Pat. No. 5,358,984, U.S. Pat. No. 5,990,232, WO 01/04178 and U.S. Pat. No. 6,013,731.

Macromers which can be used according to the invention can likewise be obtained by reaction of a linear or branched polyether alcohol or polyester alcohol having a molecular weight M_{W} of ≧1000 g/mol with an at least bifunctional isocyanate, e.g. tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpoly-methylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates, and subsequent reaction with a compound having at least one olefinically unsaturated group to form a stabilizer having at least one terminal, reactive olefinically unsaturated group. Polyetherols having an increased proportion of EO as described above are particularly preferred for achieving the required dielectric constant.

Further macromers which can be used in the process of the invention are polar polymers such as rigid or flexible foam polyether alcohols which are rich in ethylene oxide and are prepared from starter compounds such as sorbitol, trimethylolpropane (TMP) or glycerol, prepolymers derived from rigid or flexible foam polyether alcohols which are rich in ethylene oxide by reaction with TDI and/or MDI, also polyols containing sulfonic acid or sulfonate groups or acrylic acid or acrylate groups, acrylic acid or acrylate copolymers or block copolymers, polyesterols, ionic and nonionic block copolymers containing at least one terminal, reactive olefinically unsaturated group. The ethylenically unsaturated group can be inserted into a polar polymer by reaction with carboxylic anhydrides, e.g. maleic anhydride, fumaric acid, acrylate and methacrylate derivatives, or isocyanate derivatives, e.g. 3-isopropenyl-1,1-dimethylbenzyl isocyanate (TMI), isocyanatoethyl methacrylate.

In place of or in addition to the use of polyols which are rich in ethylene oxide, the required dielectric constant of the macromers can also be achieved by incorporation of polar functional groups into the macromers. This can be effected, for example, by copolymerization with compounds such as imidazoles, pyrrolidones, pyrazoles, piperazines, pyrazines, pyridazines, benzimidazoles, triazines, vinylamines, ethylenimines, acetates, acrylates, methacrylates, fumarates, vinylamides, purines, pyrimidines, pterines, aspartic acid, lactic acid, peptides, phenols, epoxides, aziridines, cellulose, saccharides, oligosaccharides, lignin, aromatic, aliphatic and araliphatic monocarboxylic, oligocarboxylic and polycarboxylic acids, aromatic, aliphatic and araliphatic monosulfonic, oligosulfonic and polysulfonic acids, aromatic, aliphatic and araliphatic amines, polyisobutenamines, salts of sulfonic and carboxylic acids. To avoid secondary reactions, preference is given to blocking the functional groups of the copolymers mentioned.

During the free-radical polymerization of the olefinic monomers in the preparation of the graft polymers, the macromers are built into the copolymer chain. This forms block copolymers which have a polyether block and a polyacrylonitrile-styrene block and act as phase compatibilizers at the interface of the continuous phase and the disperse phase and suppress agglomeration of the graft polyol particles. The proportion of macromers is usually from 1 to 35% by weight, based on the total weight of the monomers used for preparing the graft polyol, preferably from 1 to 15% by weight.

As mentioned above, it is sufficient for either only the macromer or only the carrier polyol to be polar. Preference is given to the macromer being polar, and particular preference is given to both the macromer and the carrier polyol being polar.

To prepare the graft polyols used according to the invention, it is usual to use moderators, also referred to as chain transfer agents. The use and the function of these moderators are described, for example, in U.S. Pat. No. 4,689,354 or EP 0 365 986. The moderators reduce the molecular weight of the copolymers being formed by means of chain transfer of the growing free radical, as a result of which crosslinking between the polymer molecules is reduced and the viscosity and the dispersion stability and also the filterability of the graft polyols is in turn influenced. The proportion of moderators is usually from 0.5 to 25% by weight, based on the total weight of the monomers used for preparing the graft polyol. Moderators which are customarily used for preparing graft polyols are alcohols such as 1-butanol, 2-butanol, isopropanol, ethanol, methanol, cyclohexane, toluene, mercaptans such as ethanethiol, 1-heptanethiol, 2-octanethiol, 1-dodecanethiol, thiophenol, 2-ethylhexyl thioglycolates, methyl thioglycolates, cyclohexyl mercaptan and enol ether compounds, morpholines and α-(benzoyloxy)styrene.

To initiate the free-radical polymerization, it is usual to use peroxide or azo compounds, e.g. dibenzoyl peroxide, lauroyl peroxide, t-amyl peroxy-2-ethylhexanoate, di-t-butyl peroxide, diisopropyl peroxide carbonate, t-butyl peroxy-2-ethylhexanoate, t-butyl perpivalate, t-butyl perneodecanoate, t-butyl perbenzoate, t-butyl percrotonate, t-butyl perisobutyrate, t-butyl peroxy-1-methylpropanoate, t-butylperoxy-2-ethylpentanoate, t-butyl peroxyoctanoate and di-t-butyl perphthalate, 2,2′-azobis(2,4-dimethyl-valeronitrile), 2,2′-azobisisobutyronitrile (AIBN), dimethyl 2,2′-azobisisobutyrate, 2,2′-azobis(2-methylbutyronitrile) (AMBN), 1,1′-azobis(1-cyclohexanecarbonitrile). The proportion of initiators is usually from 0.1 to 6% by weight, based on the total weight of the monomers used for preparing the graft polyol.

The free-radical polymerization for preparing graft polyols is, owing to the reaction rate of the monomers and the half-life of the initiators, usually carried out at temperatures of from 70 to 150° C. and a pressure of up to 20 bar. Preferred reaction conditions for preparing graft polyols are temperatures of from 80 to 140° C. and a pressure ranging from atmospheric pressure to 15 bar.

The use of the graft polyols employed according to the invention makes it possible to prepare polyurethane systems whose polyol component is storage-stable, so that processing, e.g. in the production of refrigeration appliances, without permanent stirring during machine foaming can become possible. This is not possible when the known, nonpolar graft polyols based on flexible foam or rigid foam carrier polyols are used.

The graft polyols used according to the invention preferably have a particle size of the polymers of from 0.1 μm to 8 μm, preferably from 0.2 μm to 4 μm, and a maximum in the particle size distribution at from 0.2 to 3 μm, preferably from 0.2 to 2.0 μm. The solids content of the graft polyols is usually in the range from 10 to 60% by weight, based on the polyol.

Preferred graft polyols are based on polyether alcohols which have a hydroxyl number of from 20 to 300 mg KOH/g and whose starter substance is trimethylolpropane, glycerol, toluenediamine (TDA) or a sugar onto which ethylene oxide or a mixture of from 50 to 90% by weight of ethylene oxide and from 10 to 50% by weight of propylene oxide is added as carrier polyols. The preferred carrier polyols can also have an end block of ethylene oxide. The graft polyols obtained in this way preferably have a hydroxyl number of from 10 to 175 mg KOH/g at a solids content of from 35 to 55% by weight, based on the total graft polyol. As monomers, preference is given to using a mixture of acrylonitrile and styrene in a weight ratio of from 1:3 to 3:1, preferably 1:2.

In a further, preferred embodiment of the graft polyols used according to the invention, the particle size distribution is bimodal, i.e. the distribution curve of the particle size has two maxima. Such graft polyols can be prepared, for example, by mixing graft polyols having monomodal particle size distributions and different particle sizes in the appropriate ratio or by using a polyol which already contains polymers of olefinically unsaturated monomers as carrier polyol in the initial charge for the reaction.

The following details may be provided regarding the remaining starting materials used for the process of the invention:

As organic polyisocyanates a), preference is given to aromatic polyfunctional isocyanates.

Specific examples are: tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products which are obtained by chemical reaction of organic diisocyanates and/or polyisocyanates. Examples which may be mentioned are diisocyanates and/or polyisocyanates containing isocyanurate and/or urethane groups. The modified polyisocyanates can, if appropriate, be mixed with one another or with unmodified organic polyisocyanates such as diphenylmethane 2,4′-, 4,4′-diisocyanate, crude MDI, tolylene 2,4- and/or 2,6-diisocyanate.

In addition, reaction products of polyfunctional isocyanates with polyhydric polyols and their mixtures with other diisocyanates and polyisocyanates can also be used.

A particularly useful organic polyisocyanate has been found to be crude MDI having an NCO content of from 29 to 33% by weight and a viscosity at 25° C. in the range from 150 to 1000 mPa·s.

As compounds having at least two hydrogen atoms which are reactive toward isocyanate b) which can be used together with the graft polyols used according to the invention, use is made, in particular, of polyether alcohols and/or polyester alcohols having OH numbers in the range from 100 to 1200 mg KOH/g.

The polyester alcohols used together with the graft polyols used according to the invention are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyether alcohols used together with the graft polyols used according to the invention usually have a functionality of from 2 to 8, in particular from 3 to 8.

In particular, polyether polyols prepared by known methods, for example by anionic polymerization of alkylene oxides in the presence of catalysts, preferably alkali metal hydroxides, are used.

Alkylene oxides used are usually ethylene oxide and/or propylene oxide, preferably pure 1,2-propylene oxide.

Starter molecules used are, in particular, compounds having at least 3, preferably from 4 to 8, hydroxyl groups or at least two primary amino groups in the molecule.

As starter molecules having at least 3, preferably from 4 to 8, hydroxyl groups in the molecule, preference is given to using trimethylolpropane, glycerol, pentaerythritol, sugar compounds such as glucose, sorbitol, mannitol and sucrose, polyhydric phenols, resols such as oligomeric condensation products of phenol and formaldehyde and Mannich condensates of phenols, formaldehyde and dialkanolamines and also melamine.

As starter molecules having at least two primary amino groups in the molecule, preference is given to using aromatic diamines and/or polyamines, for example phenylenediamines, 2,3-, 2,4-, 3,4- and 2,6-toluenediamine and 4,4′-, 2,4′- and 2,2′-diaminodiphenylmethane and also aliphatic diamines and polyamines such as ethylenediamine.

The polyether polyols have a functionality of preferably from 3 to 8 and hydroxyl numbers of preferably from 100 mg KOH/g to 1200 mg KOH/g and in particular from 240 mg KOH/g to 570 mg KOH/g.

The use of difunctional polyols, for example polyethylene glycols and/or polypropylene glycols, having a molecular weight in the range from 500 to 1500 in the polyol component enables the viscosity of the polyol component to be adapted.

The compounds having at least two hydrogen atoms which are reactive toward isocyanate b) also include the chain extenders and crosslinkers which can, if appropriate, be used concomitantly. The rigid PUR foams can be produced without or with concomitant use of chain extenders and/or crosslinkers. The addition of bifunctional chain extenders, trifunctional and higher-functional crosslinkers or, if appropriate, mixtures thereof can be found to be advantageous for modifying the mechanical properties. Chain extenders and/or crosslinkers used are preferably alkanolamines and in particular diols and/or triols having molecular weights of less than 400, preferably from 60 to 300.

Chain extenders, crosslinkers or mixtures thereof are advantageously used in an amount of from 1 to 20% by weight, preferably from 2 to 5% by weight, based on the polyol component b).

Further information on the polyether alcohols and polyester alcohols used and their preparation may be found, for example, in the Kunststoffhandbuch, Volume 7 “Polyurethane”, edited by Günter Oertel, Carl-Hanser-Verlag Munich, 3^{rd} edition, 1993.

Catalysts c) used are, in particular, compounds which strongly accelerate the reaction of the isocyanate groups with the groups which are reactive toward isocyanate groups. Such catalysts are strongly basic amines, e.g. secondary aliphatic amines, imidazoles, amidines and alkanolamines, or organic metal compounds, in particular organic tin compounds.

When isocyanurate groups are also to be incorporated in the rigid polyurethane foam, specific catalysts are required for this purpose. As isocyanurate catalysts, use is usually made of metal carboxylates, in particular potassium acetate and solutions thereof.

The catalysts can, depending on requirements, be used either alone or in any mixtures with one another.

As blowing agent d) preference is given to using water which reacts with isocyanate groups to eliminate carbon dioxide. It is also possible to use physical blowing agents in combination with or in place of water. These are compounds which are inert toward the starting components and are usually liquid at room temperature and vaporize under the conditions of the urethane reaction. The boiling point of these compounds is preferably below 50° C. Physical blowing agents also include compounds which are gaseous at room temperature and are introduced under pressure into the starting components or are dissolved therein, for example carbon dioxide, low-boiling alkanes and fluoroalkanes.

The compounds are usually selected from the group consisting of alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and 1,1,1,2,3,3,3-heptafluoropropane and also perfluoroalkanes such as C₃F₈, C₄F₁₀, C₅F₁₂, C₆F₁₄ and C₇F₁₇. The physical blowing agents mentioned can be used alone or in any combinations with one another.

The process of the invention can, if required, be carried out in the presence of flame retardants and also customary auxiliaries and/or additives.

As flame retardants, it is possible to employ organic phosphoric and/or phosphonic esters. Preference is given to using compounds which are not reactive toward isocyanate groups. Preferred compounds also include chlorine-containing phosphoric esters.

Typical representatives of this group of flame retardants are triethyl phosphate, diphenyl cresyl phosphate, tris(chloropropyl) phosphate and diethyl ethanephosphonate.

It is also possible to use bromine-containing flame retardants. As bromine-containing flame retardants, preference is given to using compounds which have groups which are reactive toward the isocyanate group. Such compounds are esters of tetrabromophthalic acid with aliphatic diols and alkoxylation products of dibromobutenediol. Compounds derived from the series of brominated, OH-containing neopentyl compounds can also be employed.

Auxiliaries and/or additives used are the materials known per se for this purpose, for example surface-active substances, foam stabilizers, cell regulators, fillers, pigments, dyes, flame retardants, hydrolysis inhibitors, antistatics, fungistatic and bacteriostatic agents.

Further details regarding the starting materials, blowing agents, catalysts and auxiliaries and/or additives used for carrying out the process of the invention may be found, for example, in the Kunststoffhandbuch, Volume 7, “Polyurethane” Carl-Hanser-Verlag Munich, 1^{st} edition, 1966, 2^{nd} edition, 1983 and 3^{rd} edition, 1993.

To produce the rigid polyurethane foams, the polyisocyanates a) and the compounds having at least two hydrogen atoms which are reactive toward isocyanate groups b) are reacted in such amounts that the isocyanate index is in the range from 100 to 220, preferably from 115 to 195. The rigid polyurethane foams can be produced batchwise or continuously with the aid of known mixing apparatuses.

In the production of polyisocyanurate foams, a higher index, preferably up to 350, can also be employed.

The rigid PUR foams produced according to the invention are usually produced by the two-component process. In this process, the compounds having at least two hydrogen atoms which are reactive toward isocyanate groups b) are mixed with the flame retardants, the catalysts c), the blowing agents d) and the further auxiliaries and/or additives to form a polyol component and this is reacted with the polyisocyanates or mixtures of the polyisocyanates and, if appropriate, blowing agents, also referred to as isocyanate component.

The starting components are usually mixed at a temperature of from 15 to 35° C., preferably from 20 to 30° C. The reaction mixture can be introduced into closed support tools by means of high- or low-pressure metering machines. For example, sandwich elements can be manufactured batchwise using this technology.

Furthermore, the reaction mixture can also be poured or sprayed free onto surfaces or into open hollow spaces. Roofs or complicated containers can be insulated on site by this method.

Continuous mixing of the isocyanate component with the polyol component to produce sandwich elements or insulation elements on double-belt units is also a preferred embodiment of the process of the invention. In this technology, it is customary to meter the catalysts and the blowing agents into the polyol component via further metering pumps. Here, the components used can be divided up into up to 8 single components. The foaming formulations can readily be converted from the two-component process to the processing of multicomponent systems.

The rigid polyurethane foams produced by the process of the invention have, as indicated above, optimal processing properties, in particular good curing. Surprisingly, the rigid polyurethane foams produced by the process of the invention display a reduced tendency to form voids.

As a result of the increased proportion (compared to customary graft polyols) of ethylene oxide units in the carrier polyol and in the macromer, phase-stable formulations for producing rigid foams are obtained. The equipment corresponding to the prior art can therefore be used for foaming, e.g. in the production of refrigeration appliances or in the continuous manufacture of sandwich panels. Continually stirring of the polyol mixture during machine foaming is thus not necessary. The rigid foams produced by the process of the invention are virtually completely closed-celled despite the use of graft polyols.

The graft polyols used according to the invention can in principle also be used for producing flexible foams. The graft polyols used according to the invention are phase-stable in the polyol components typical for the production of flexible foams and make processing in accordance with the prior art possible. In particular, the polar graft polyols can be used advantageously in the production of highly elastic, open-celled flexible polyurethane foams. The foams produced in this way also have good mechanical properties.

The invention is illustrated by the following examples.

Measurement Methods
1) The viscosity of the polyols was determined at 25° C. by means of a rotational viscometer Rheotec RC 20 using the spindle CC 25 DIN (spindle diameter: 12.5 mm; internal diameter of measurement cylinder: 13.56 mm) at a shear rate of 50 1/s.
2) The solids content of the graft polyols and the graft polyol mixtures was determined gravimetrically. For this purpose, about 2 g of graft polyol were finely dispersed in about 80 g of isopropanol or methanol in a centrifuge tube. The solid was subsequently separated off in a high-speed centrifuge Sorvall RC 26 Plus at 20 000 rpm (44 670 g). After the liquid phase present above the solid had been decanted off, the solid was redispersed twice more in isopropanol or methanol, followed by centrifugation and removal of the liquid phase. After the solid had been dried at 80° C. and a pressure of <1 mbar in a vacuum drying oven for at least two hours, the percentage solids content was calculated from the mass of the solid separated off and the mass of the graft polyol used.
3) The dielectric constant ε′ of the polyols and macromers was determined in accordance with DIN 53 483. The values measured at 23° C. and 1000 Hz are reported.
4) Curing was determined by means of the indentation test. For this purpose, a steel indenter having a hemispherical end with a radius of 10 mm was pressed by means of a tensile/compressive testing machine to a depth of 10 mm into the foam formed 2, 3 and 4 minutes after mixing of the components in a polystyrene cup. The maximum force in N necessary for this is a measure of the curing of the foam. The sum of the measured maximum forces after 2, 3 and 4 minutes is reported in each case.
5) The flowability was determined by means of the hose test. For this purpose, 100 g of the reaction mixture obtained by mixing the components are poured into a plastic hose having a diameter of 45 mm and the hose is closed. The length of the flow path in the plastic hose in cm is a measure of the flowability.
6) The thermal conductivity was determined in accordance with DIN 52616. To produce the test specimens, the polyurethane reaction mixture was poured into a mold having the dimensions 22.5×22.5×22 cm (10% overfilling) and a test specimen having the dimensions 20×20×5 cm was cut from the middle after a number of hours.
7) The compressive strength was determined in accordance with DIN 53 421/ DIN EN ISO 604
8) The proportion of closed cells was determined in accordance with ISO 4590.
9) Visual assessment of the foam structure/fine-celled nature of the foam. 1: very fine-celled; 2: fine-celled; 3: slightly coarse-celled; 4: coarse-celled.
10) Visual assessment of the tendency to form bottom defects or voids in sandwich elements. 1: very smooth surface, no bottom defects/voids on the underside of the sandwich element; 2: very scattered slight bottom defects/voids on the underside of the sandwich element; 3: some bottom defects/voids on the underside of the sandwich element; 4: severe bottom defects over the entire area of the underside of the sandwich element.
11) Assessment of curing of the sandwich elements at the end of the belt: 1: minimal change in the element thickness after 24 hours; 2: slight change in the element thickness after 24 hours; 3: significant change in the element thickness after 24 hours.
12) The burning behavior was determined in the small burner test in accordance with DIN 4102

Preparation of Macromers 1 and 7

The base polyol having a water content of <0.02% by weight was admixed with calcium naphthenate (0.5% by weight based on the base polyol) and maleic anhydride (0.8 mol per mole of base polyol). The reaction mixture was heated to 125° C. under a nitrogen atmosphere while stirring. During the subsequent two hour reaction time, the monoester of maleic acid with the base polyol was formed. After the reaction mixture had been heated to 143° C., an excess of propylene oxide (4.4 times the molar amount of maleic anhydride) was added. The mixture was allowed to react for a further eight hours. At the end of the reaction time, the excess of propylene oxide was removed under reduced pressure, the product was cooled to 25° C. and stabilized with antioxidants.

Preparation of the Macromers 2-4, 6, 8 and 9

The base polyol having a water content of <0.02% by weight was admixed at a temperature of 80° C. with dibutyltin dilaurate as esterification catalyst and 3-iso-propenyl-α,α-dimethylbenzyl isocyanate (TMI) (0.8 mol per mole of base polyol) while stirring. The mixture was stirred at 80° C. for a further one hour. Phosphoric acid was subsequently added to deactivate the catalyst and the product was cooled to 25° C. and stabilized with antioxidants.

Preparation of the Macromer 5

The base polyol having a water content of <0.02% by weight was admixed at a temperature of 80° C. with dibutyltin dilaurate as esterification catalyst and TDI (tolylene 2,4- and 2,6-diisocyanate and the corresponding isomer mixtures) while stirring. 3-Iso-propenyl-α,α-dimethylbenzyl isocyanate (TMI) was subsequently added. The total amount of isocyanate was 0.8 mol per mole of base polyol. The mixture was stirred at 80° C. for a further one hour. Phosphoric acid was subsequently added to deactivate the catalyst and the product was cooled to 25° C. and stabilized with antioxidants.

Preparation of the Macromer 10

The base polyesterol based on adipic acid and monoethylene glycol and having a molar mass of 2000 g/mol and a hydroxyl number of 55 mg KOH/g was admixed at a temperature of 80° C. with dibutyltin dilaurate as esterification catalyst and 3-iso-propenyl-α,α-dimethylbenzyl isocyanate (TMI) (0.8 mol per mole of base polyesterol) while stirring. The mixture was stirred at 80° C. for a further 8 hours. Phosphoric acid was subsequently added to deactivate the catalyst and the product was cooled to 25° C. and stabilized with antioxidants.

Preparation of the Graft Polyols.

The graft polyols used in the following examples were prepared in continuous processes and batch processes. The synthesis of graft polyols by both methods is known and is described, for example, in EP 439755. A special form of the semibatch process is the semibatch seed process in which a graft polyol is additionally used as seed in the initial charge for the reaction, for example as described in EP 510533. The synthesis of graft polyols having a bimodal particle size distribution is described in WO 03/078496. The synthesis of graft polyols in a continuous process is likewise known and is described, for example, in WO 00/59971.

Graft Polyols Prepared in a Semibatch Process

The preparation of the graft polyols by the semibatch process was carried out in a 2 liter autoclave equipped with a 2-stage agitator, internal cooling coils and an electric heating jacket. Before commencement of the reaction, the reactor was charged with a mixture of carrier polyol and macromer, flushed with nitrogen and heated to the synthesis temperature of 125 or 130° C. In some syntheses, a graft polyol was additionally added as seed in addition to the carrier polyol and the macromer in the initial charge for the reaction. In a further group of experiments, only part of the macromer was placed in the reactor initially. The remaining amount was introduced into the reactor via an independent feed stream during the synthesis. Beginning and end of the introduction of macromer are shown in table 3. The remainder of the reaction mixture, comprising further carrier polyol, initiator, the monomers and the reaction moderator, was placed in at least two metered addition vessels. The synthesis of the graft polyols wag carried out by feeding the raw materials from the metered addition vessels at a constant metering rate via a static in-line mixer into the reactor. The addition time for the monomer/moderator mixture was 150 or 180 minutes, while the polyol/initiator mixture was metered into the reactor over 165 or 195 minutes. After a further after-reaction time of from 10 to 30 minutes at the reaction temperature, the crude graft polyol was transferred via the bottom outlet valve into a glass flask. The product was subsequently freed of the unreacted monomers and other volatile compounds under reduced pressure (<0.1 mbar) at a temperature of 135° C. The end product was subsequently stabilized with antioxidants.

TABLE 1
Graft polyols prepared in a semibatch process

| | Polyol 1 | Polyol 2 | Polyol 3 | Polyol 4 | Polyol 5 | Polyol 6 | |
|---|---|---|---|---|---|---|---|
| | Comparative | Comparative | Comparative | Comparative | Comparative | Comparative | |
| Experiment | example | example | example | example | example | example | Polyol 7 |
| Temperature (° C.) | 125 | 125 | 125 | 125 | 125 | 125 | 125 |
| Initial pressure (bar) | 0 | 0 | 0 | 0 | 0 | 0 | 0 |
| Initial charge in the reactor | | | | | | | |
| Carrier polyol (g) | Polyol 8 | Polyol 8 | Polyol 8 | Polyol 8 | Polyol 9 | Polyol 10 | Polyol 11 |
| | 156.81 | 155.16 | 155.16 | 291.30 | 298.91 | 64.39 | 179.38 |
| Macromer (g) | Mac. 1 | Mac. 2 | Mac. 3 | Mac. 3 | Mac. 3 | VMac. 3 | Mac. 4 |
| | 10.99 | 14.39 | 14.39 | 68.02 | 52.32 | 6.54 | 16.80 |
| Seed | — | — | — | — | — | — | — |
| Feed stream 1 | | | | | | | |
| Acrylonitrile (g) | 87.19 | 87.19 | 87.19 | 174.38 | 174.38 | 36.33 | 69.99 |
| Styrene (g) | 174.41 | 174.41 | 174.41 | 348.82 | 348.82 | 72.67 | 140.01 |
| N-Dodecanethiol (g) | 2.75 | 2.75 | 2.75 | 5.49 | 4.49 | 1.14 | 2.21 |
| Addition time (min) | 150 | 150 | 150 | 150 | 150 | 150 | 150 |
| Feed stream 2 | | | | | | | |
| Carrier polyol (g) | Polyol 8 | Polyol 8 | Polyol 8 | Polyol 8 | Polyol 9 | Polyol 10 | Polyol 11 |
| | 166.64 | 164.89 | 164.89 | 309.56 | 317.65 | 68.42 | 190.63 |
| Initiator (g) | Initiator 1 | Initiator 1 | Initiator 1 | Initiator 1 | Initiator 1 | Initiator 1 | Initiator 1 |
| | 1.22 | 1.22 | 1.22 | 2.43 | 2.43 | 0.51 | 0.98 |
| Addition time (min) | 165 | 165 | 165 | 165 | 165 | 165 | 165 |
| Properties | | | | | | | |
| Viscosity (mPas) | 4900 | 3800 | 3900 | 5800 | 3600 | 3200 | 7600 |
| Solids content (% by | 45 | 45 | 45 | 45 | 45 | 42 | 35 |
| weight) | | | | | | | |

TABLE 2
Graft polyols prepared in a semibatch process

| Experiment | Polyol 12 | Polyol 13 | Polyol 14 | Polyol 15 | Polyol 16 | Polyol 17 | Polyol 18 | Polyol 19 |
|---|---|---|---|---|---|---|---|---|
| Temperature (° C.) | 125 | 125 | 125 | 125 | 125 | 125 | 125 | 125 |
| Initial pressure (bar) | 0 | 0 | 0 | 0 | 0 | 0 | 0 | 0 |
| Initial charge in the | | | | | | | | |
| reactor | | | | | | | | |
| Carrier polyol (g) | Polyol 20 | Polyol 10 | Polyol 21 | Polyol 11 | Polyol 11 | Polyol 11 | Polyol 22 | Polyol 8, |
| | 358.77 | 74.74 | 363.86 | 356.73 | 727.72 | 600.59 | 617.20 | Polyol 23 |
| | | | | | | | | (1:1) |
| | | | | | | | | 356.73 |
| Macromer (g) | Mac. 3 | Mac. 4 | Mac. 5 | Mac. 6 | Mac. 6 | Mac. 6 | Mac. 7 | Mac. 6 |
| | 33.60 | 7.00 | 23.10 | 37.80 | 46.20 | 64.80 | 42.72 | 37.80 |
| Seed | — | — | — | — | Polyol 15 | Polyol 15 | Polyol 24 | — |
| | | | | | 180.00 | 231.43 | 184.95 | |
| Feed stream 1 | | | | | | | | |
| Acrylonitrile (g) | 139.99 | 29.16 | 139.99 | 139.99 | 279.97 | 359.96 | 355.96 | 139.99 |
| Styrene (g) | 280.01 | 58.34 | 280.01 | 280.01 | 560.03 | 720.04 | 712.04 | 280.01 |
| N-Dodecanethiol (g) | 4.41 | 0.92 | 4.41 | 4.41 | 8.82 | 11.34 | 11.21 | 4.41 |
| Addition time (min) | 150 | 150 | 150 | 150 | 150 | 150 | 150 | 150 |
| Feed stream 2 | | | | | | | | |
| Carrier polyol (g) | Polyol 20 | Polyol 10 | Polyol 21 | Polyol 11 | Polyol 11 | Polyol 11 | Polyol 22 | Polyol 8, |
| | 381.27 | 79.43 | 386.68 | 379.10 | 773.35 | 638.25 | 655.90 | Polyol 23 |
| | | | | | | | | (1:1) |
| | | | | | | | | 379.10 |
| Initiator (g) | Initiator 1 | Initiator 1 | Initiator 1 | Initiator 1 | Initiator 1 | Initiator 1 | Initiator 1 | Initiator 1 |
| | 1.95 | 0.41 | 1.95 | 1.95 | 3.91 | 5.02 | 4.97 | 1.95 |
| Addition time (min) | 165 | 165 | 165 | 165 | 165 | 165 | 165 | 165 |
| Properties | | | | | | | | |
| Viscosity (mPas) | 30000 | 35000 | 5000 | 6600 | 8900 | 40000 | 17400 | 2500 |
| Solids content (% by | 40 | 35 | 35 | 35 | 35 | 45 | 45 | 35 |
| weight) | | | | | | | | |

TABLE 3
Graft polyols prepared in a semibatch process

| | Polyol 25 | Polyol 26 | |
|---|---|---|---|
| | Comparative | Comparative | |
| Experiment | example | example | Polyol 27 |
| Temperature (° C.) | 125 | 125 | 125 |
| Initial pressure (bar) | 0 | 0 | 0 |
| Initial charge in the | | | |
| reactor | | | |
| Carrier polyol (g) | Polyol 28 | Polyol 29 | Polyol 8, |
| | 629.07 | 610.29 | Polyol 23 (1:1) |
| | | | 356.73 |
| Macromer (g) | Mac. 8 | Mac. 9 | Mac. 10 |
| | 22.26 | 48.35 | 37.80 |
| Seed | Polyol 30 | Polyol 30 | — |
| | 193.99 | 196.19 | |
| Feed stream 1 | | | |
| Acrylonitrile (g) | 360.11 | 364.20 | 139.99 |
| Styrene (g) | 720.34 | 728.50 | 280.01 |
| N-Dodecanethiol (g) | 11.35 | 11.47 | 4.41 |
| Addition time (min) | 150 | 150 | 150 |
| Feed stream 2 | | | |
| Carrier polyol (g) | Polyol 28 | Polyol 29 | Polyol 8, |
| | 668.52 | 648.56 | Polyol 23 (1:1) |
| | | | 379.10 |
| Initiator (g) | Initiator 1 | Initiator 1 | Initiator 1 |
| | 4.97 | 5.03 | 1.95 |
| Addition time (min) | 165 | 165 | 165 |
| Feed stream 3 | | | |
| Macromer | Mac. 8 | Mac. 9 | — |
| | 33.39 | 33.30 | |
| Addition time (min) | 13-16 | 14.5 | — |
| Properties | | | |
| Viscosity (mPas) | 7300 | 4600 | 30000 |
| Solids content (% by | 45 | 45 | 35 |
| weight) | | | |

### EXAMPLES 1-16, COMPARATIVE EXAMPLES 1-3 and A to H

### Production of Rigid Foams for Use in Refrigeration Appliances (Machine Foaming)

The various polyols, stabilizers, catalysts are mixed with water and the blowing agent in the ratios indicated in tables 4-6. 100 parts by weight of the polyol component were mixed with the amount indicated in tables 4-6 of a mixture of diphenylmethane diisocyanate and polyphenylenepolymethylene polyisocyanate having an NCO content of 31.5% by weight and a viscosity of 200 mPas (25° C.) in a Puromat® HD 30 high-pressure foaming machine (Elastogran GmbH). The reaction mixture was injected into a mold having the dimensions 200 cm×20 cm×5 cm or 40 cm×70 cm×9 cm and allowed to foam there. The properties and data of the foams obtained are reported in tables 4-6.

In the comparative examples A to H, the graft polyol was mixed with the other components directly in the mixing head.

TABLE 4
Production of the foams (machine foaming)

| | Comp. | Comp. | Comp. | | | | | Comp. | |
|---|---|---|---|---|---|---|---|---|---|
| | Ex. 1 | Ex. A | Ex. B | Ex. 1 | Ex. 2 | Ex. 3 | Ex. 4 | Ex. C | Ex. 5 |
| Polyol 40 | 20 | 20 | 20 | 20 | 20 | 20 | 20 | 20 | 20 |
| Polyol 41 | 36 | 16 | 16 | 16 | 16 | 16 | 16 | 16 | 16 |
| Polyol 42 | 30 | 30 | 30 | 30 | 30 | 30 | 30 | 30 | 30 |
| Castor oil | 7 | 7 | 7 | 7 | 7 | 7 | 7 | 7 | 7 |
| Polyol 1 | | 20 | | | | | | | |
| Polyol 5 | | | 20 | | | | | | |
| Polyol 7 | | | | 20 | | | | | |
| Polyol 13 | | | | | 20 | | | | |
| Polyol 14 | | | | | | 20 | | | |
| Polyol 17 | | | | | | | 20 | | |
| Polyol 25 | | | | | | | | 20 | |
| Polyol 27 | | | | | | | | | 20 |
| Stabilizer 1 | 2 | 2 | 2 | 2 | 2 | 2 | 2 | 2 | 2 |
| Water | 2.3 | 2.3 | 2.3 | 2.3 | 2.3 | 2.3 | 2.3 | 2.3 | 2.3 |
| Catalyst 1 | 0.7 | 0.7 | 0.7 | 0.7 | 0.7 | 0.7 | 0.7 | 0.7 | 0.7 |
| Catalyst 2 | 0.7 | 0.7 | 0.7 | 0.7 | 0.7 | 0.7 | 0.7 | 0.7 | 0.7 |
| Catalyst 3 | 0.7 | 0.7 | 0.7 | 0.7 | 0.7 | 0.7 | 0.7 | 0.7 | 0.7 |
| Cyclopentane 95% | 14 | 14 | 14 | 14 | 14 | 14 | 14 | 14 | 14 |
| Phase stability of the | No | Demixed | Demixed | No | No | No | No | No | Demixed |
| mixture [23°] | demixing | after 90 | after 90 | demixing | demixing | demixing | demixing | demixing | after 30 |
| | after 2 | minutes | minutes | after 2 | after 2 | after 2 | after 2 | after 2 | minutes |
| | weeks | | | weeks | weeks | weeks | weeks | weeks | |
| Mixing ratio 100: | 139 | 122 | 122 | 119 | 120 | 119 | 119 | 119 | 125 |
| Index | 125 | 125 | 125 | 125 | 125 | 125 | 125 | 125 | 125 |
| Fiber time [s] | 44 | 41 | 41 | 41 | 42 | 47 | 45 | 44 | 43 |
| Free-foamed density | 22.0 | 22.2 | 21.3 | 21.6 | 21.6 | 21.9 | 21.9 | 21.6 | 21.7 |
| [g/l] | | | | | | | | | |
| Minimum fill density | 31.8 | 31.9 | 31.2 | 31.7 | 31.5 | 31.5 | 32.2 | 32.0 | 31.7 |
| [g/l] | | | | | | | | | |
| Flow factor (min. fill | 1.45 | 1.44 | 1.46 | 1.47 | 1.46 | 1.44 | 1.47 | 1.48 | 1.46 |
| density/free foam | | | | | | | | | |
| density) | | | | | | | | | |
| Proportion of open | 6 | 7 | 4 | 6 | 4 | 5 | 8 | 6 | 6 |
| cells [%] | | | | | | | | | |
| Thermal conductivity | 19.3 | 19.2 | 19.6 | 19.8 | 19.5 | 19.4 | 19.2 | 19.4 | 19.3 |
| [mW/mK] | | | | | | | | | |
| Compressive | 0.135 | 0.13 | 0.14 | 0.13 | 0.13 | 0.13 | 0.135 | 0.12 | 0.14 |
| strength (RD 31), | | | | | | | | | |
| 10% OP [N/mm²]] | | | | | | | | | |

TABLE 5
Production of the foams (machine foaming)

| | Comp. | | | Comp. | Comp. | Comp. | Comp. | | |
|---|---|---|---|---|---|---|---|---|---|
| | Ex. 2 | Ex. 6 | Ex. 7 | Ex. D | Ex. E | Ex. F | Ex. G | Ex. 8 | Ex. 9 |
| Polyol 42 | 30 | 30 | 30 | 30 | 30 | 30 | 30 | 30 | 30 |
| Polyol 43 | 48 | 48 | 48 | 48 | 48 | 48 | 48 | 48 | 48 |
| Polyol 44 | 16 | 16 | | 16 | | | | | |
| Polyol 45 | | | 16 | | | | | | |
| Polyol 17 | | 10 | 10 | | | | | | |
| Polyol 25 | | | | 10 | 16 | | | | |
| Polyol 30 | | | | | | 16 | | | |
| Polyol 1 | | | | | | | 16 | | |
| Polyol 7 | | | | | | | | 16 | |
| Polyol 19 | | | | | | | | | 16 |
| Stabilizer 2 | 2 | 2 | 2 | 2 | 2 | 2 | 2 | 2 | 2 |
| Water | 2.3 | 2.3 | 2.3 | 2.3 | 2.3 | 2.3 | 2.3 | 2.3 | 2.3 |
| Catalyst 1 | 1.2 | 1.2 | 1.2 | 1.2 | 1.2 | 1.2 | 1.2 | 1.2 | 1.2 |
| Catalyst 4 | 0.4 | 0.4 | 0.4 | 0.4 | 0.4 | 0.4 | 0.4 | 0.4 | 0.4 |
| Catalyst 5 | 0.5 | 0.5 | 0.5 | 0.5 | 0.5 | 0.5 | 0.5 | 0.5 | 0.5 |
| Cyclopentane 70% | 14 | 14 | 14 | 14 | 14 | 14 | 14 | 14 | 14 |
| Phase stability of | No | No | No | Demixed | Demixed | Demixed | Demixed | No | No |
| polyol [23°] | demixing | demixing | demixing | after 30 | after 30 | after 30 | after 90 | demixing | demixing |
| | after 2 | after 2 | after 2 | minutes | minutes | minutes | minutes | after 2 | after 2 |
| | weeks | weeks | weeks | | | | | weeks | weeks |
| Mixing ratio 100: | 125 | 116 | 116 | 116 | 119 | 120 | 122 | 120 | 114 |
| Index | 117 | 117 | 117 | 117 | 117 | 117 | 117 | 117 | 117 |
| Fiber time [s] | 39 | 41 | 40 | 41 | 38 | 42 | 45 | 44 | 44 |
| Free-foamed | 24.4 | 24.3 | 23.7 | 24.0 | 23.9 | 23.3 | 24.3 | 23.8 | 24.0 |
| density [g/l] | | | | | | | | | |
| Minimum fill | 31.9 | 32.2 | 31.8 | 32.4 | 31.8 | 31.5 | 32.3 | 31.7 | 32.2 |
| density [g/l] | | | | | | | | | |
| Flow factor (min. | 1.31 | 1.33 | 1.34 | 1.35 | 1.33 | 1.35 | 1.33 | 1.33 | 1.34 |
| fill density/free | | | | | | | | | |
| foam density) | | | | | | | | | |
| Proportion of open | 6 | 5 | 7 | 4 | 5 | 5 | 6 | 4 | 5 |
| cells [%] | | | | | | | | | |
| Thermal | 19.7 | 19.5 | 20.1 | 19.8 | 19.7 | 19.5 | 19.7 | 20.0 | 19.8 |
| conductivity | | | | | | | | | |
| [mW/mK] | | | | | | | | | |
| Compressive | 0.15 | 0.15 | 0.14 | 0.15 | 0.15 | 0.16 | 0.14 | 0.15 | 0.15 |
| strength (RD 31), | | | | | | | | | |
| 10% OP [N/mm²]] | | | | | | | | | |

TABLE 6
Production of the foams (machine foaming)

| | Comp. | Comp. | | | | | | | |
|---|---|---|---|---|---|---|---|---|---|
| | Ex. 3 | Ex. H | Ex. 10 | Ex. 11 | Ex. 12 | Ex. 13 | Ex. 14 | Ex. 15 | Ex. 16 |
| Polyol 42 | 20 | 20 | 20 | 20 | 20 | 20 | 20 | 20 | 20 |
| Polyol 43 | 56.6 | 56.6 | 56.6 | 56.6 | 56.6 | 56.6 | 56.6 | 56.6 | 56.6 |
| Polyol 44 | 18 | | | | | | | | |
| Polyol 25 | | 18 | | | | | | | |
| Polyol 17 | | | 18 | 18 | 18 | 18 | 18 | 18 | 18 |
| Stabilizer 2 | 2 | 2 | 2 | 2 | 2 | 2 | 2 | 2 | 2 |
| Water | 2.3 | 2.3 | 2.3 | 2.3 | 2.3 | 2.3 | 2.3 | 2.3 | 2.3 |
| Catalyst 1 | 0.9 | 1.2 | 1.2 | 0.9 | 0.9 | 2.5 | 2.0 | 2.2 | 0.6 |
| Catalyst 4 | 0.4 | 0.4 | 0.4 | 0.4 | 0.4 | 0.6 | 0.8 | 0.6 | 0.4 |
| Catalyst 5 | 0.5 | 0.5 | 0.5 | 0.5 | 0.5 | 1.0 | 1.2 | 0.9 | 0.5 |
| Cyclopentane | 14 | 14 | 14 | 9.8 | 12 | | | | 8 |
| Isopentane | | | | 4.2 | | | | | 3.5 |
| Isobutane | | | | | 2 | | | | |
| HFC 245fa | | | | | | 35 | | | |
| HFC 365mfc | | | | | | | 35 | | |
| HFC 141b | | | | | | | | 35 | |
| Formic acid | | | | | | | | | 4.5 |
| Phase stability of | No demixing | Demixed | No | No | No | No | No | No | No |
| polyol [23°] | after 2 | after 30 | demixing | demixing | demixing | demixing | demixing | demixing | demixing |
| | weeks | minutes | after 2 | after 2 | after 2 | after 2 | after 2 | after 2 | after 2 |
| | | | weeks | weeks | weeks | weeks | weeks | weeks | weeks |
| Mixing ratio 100: | 125 | 119 | 119 | 119 | 119 | 99 | 99 | 100 | 117 |
| Index | 117 | 117 | 117 | 117 | 117 | 117 | 117 | 117 | 117 |
| Fiber time [s] | 43 | 41 | 41 | 38 | 41 | 38 | 42 | 39 | 38 |
| Free-foamed | 23.8 | 22.5 | 23.8 | 22.3 | 23.0 | 22.5 | 22.0 | 21.6 | 20.8 |
| density [g/l] | | | | | | | | | |
| Minimum fill | 31.6 | 30.1 | 31.9 | 30.1 | 31.0 | 28.8 | 29.5 | 30.6 | 28.3 |
| density [g/l] | | | | | | | | | |
| Flow factor (min. | 1.33 | 1.34 | 1.34 | 1.35 | 1.35 | 1.30 | 1.34 | 1.42 | 1.36 |
| fill density/free | | | | | | | | | |
| foam density) | | | | | | | | | |
| Proportion of open | 6 | 6 | 6 | 7 | 6 | 5 | 5 | 4 | 6 |
| cells [%] | | | | | | | | | |
| Thermal | 20.0 | 19.7 | 19.8 | 20.3 | 19.8 | 17.9 | 18.7 | 16.8 | 19.6 |
| conductivity | | | | | | | | | |
| [mW/mK] | | | | | | | | | |
| Compressive | 0.15 | 0.15 | 0.15 | 0.15 | 0.14 | 0.13 | 0.14 | 0.13 | 0.13 |
| strength (RD 31), | | | | | | | | | |
| 10% OP [N/mm²] | | | | | | | | | |
| Further rise after | 92.0 | 90.9 | 91.2 | 91.0 | 91.4 | 91.3 | 91.3 | 91.1 | 91.8 |
| 24 h, 5 min., 10% | | | | | | | | | |
| overpack [mm] | | | | | | | | | |

### EXAMPLES 17 to 23 and COMPARATIVE EXAMPLES 4 to 6 and I to U

### Production of Sandwich Elements

A polyol component was prepared from the starting materials listed in tables 4, 5 and 6 and reacted in the mixing ratio indicated on a double-belt unit with a mixture of diphenylmethane diisocyanate and polyphenylenepolymethylene polyisocyanate having an NCO content of 31.0% by weight and a viscosity of 520 mPas (25° C.) to produce a sandwich element having a thickness of 80 mm or 120 mm. In the comparative examples I to U, the graft polyol or a storage-stable mixture comprising graft polyol and polyol 42 was mixed with the other components directly in the mixing head.

The raw materials used and the properties of the sandwich elements are reported in tables 3 to 5. All rigid foams in all examples and comparative examples conform to thermal conductivity group 25 as specified in DIN 18 164 Part 1.

TABLE 7

| | Comp. | Comp. | Comp. | Comp. | Comp. | | | |
|---|---|---|---|---|---|---|---|---|
| | Ex. 4 | Ex. I | Ex. J | Ex. K | Ex. L | Ex. 17 | Ex. 18 | Ex. 19 |
| Polyol 46 | 20 | 20 | 20 | 20 | 20 | 20 | 20 | 20 |
| Polyol 47 | 18.5 | 18.5 | 18.5 | 18.5 | 18.5 | 18.5 | 18.5 | 18.5 |
| Polyol 48 | 16 | 16 | 16 | 16 | 16 | 16 | 16 | 16 |
| Polyol 49 | 20 | 20 | 20 | 20 | 20 | 20 | 20 | 20 |
| Polyol 50 | 10 | 10 | 10 | 10 | 10 | 10 | 10 | 10 |
| Glycerol | 2 | 2 | 2 | 2 | 2 | 2 | 2 | 2 |
| Dipropylene | 0.2 | 0.2 | 0.2 | 0.2 | 0.2 | 0.2 | 0.2 | 0.2 |
| glycol | | | | | | | | |
| Polyol 26 | | 2.5 | 5 | | | | | |
| Polyol 52 | | 2 | | 2 | | | | |
| Polyol 25 | | | | 2.5 | | | | |
| Polyol 5 | | | | | 5 | | | |
| Polyol 7 | | | | | | 5 | | |
| Polyol 13 | | | | | | | 5 | |
| Polyol 20 | | | | | | | | 5 |
| Flame retardant 1 | 12 | 12 | 12 | 12 | 12 | 12 | 12 | 12 |
| Stabilizer 3 | 1 | 1.5 | 1 | 1.5 | 1 | 1 | 1.5 | 1 |
| Catalyst 1 | 4.6 | 4.6 | 4.6 | 4.6 | 4.6 | 4.6 | 4.6 | 4.6 |
| Water | 2.5 | 2.5 | 2.5 | 2.5 | 2.5 | 2.5 | 2.5 | 2.5 |
| n-Pentane | 7.0 | 7.0 | 7.0 | 7.0 | 7.0 | 7.0 | 7.0 | 7.0 |
| Phase stability of | No demixing | Demixed | Demixed | Demixed | Demixed | No | No | No |
| polyol [23°] | after 2 | after 1 hour | after 1 hour | after 1 hour | after 1 hour | demixing | demixing | demixing |
| | weeks | | | | | after 2 | after 2 | after 2 |
| | | | | | | weeks | weeks | weeks |
| Mixing ratio 100: | 119 | 119 | 119 | 119 | 119 | 119 | 119 | 119 |
| Cream time [s] | 15 | 14 | 15 | 15 | 14 | 16 | 16 | 15 |
| Fiber time [s] | 45 | 44 | 46 | 45 | 44 | 45 | 46 | 46 |
| Foam density | 42 | 43 | 42 | 44 | 41 | 42 | 42 | 43 |
| [g/l] | | | | | | | | |
| Element | 80 | 80 | 80 | 80 | 80 | 80 | 80 | 80 |
| thickness [mm] | | | | | | | | |
| Indentation test | 168 | 195 | 221 | 203 | 228 | 231 | 219 | 227 |
| [N] | | | | | | | | |
| Proportion of | 8 | 9 | 7 | 8 | 6 | 9 | 10 | 8 |
| open cells [%] | | | | | | | | |
| Burning behavior | B3 | B3 | B3 | B3 | B3 | B3 | B3 | B3 |
| (DIN 4102) | | | | | | | | |
| Curing at the end | 3 | 2 | 1-2 | 2 | 1-2 | 1-2 | 1-2 | 1-2 |
| of the belt | | | | | | | | |
| Frequency of | 3 | 2 | 1-2 | 2 | 1-2 | 1-2 | 1-2 | 1-2 |
| voids | | | | | | | | |
| Foam structure | 2 | 2 | 2 | 2 | 2 | 2 | 2 | 2 |

TABLE 8

| | Comp. | Comp. | Comp. | Comp. | Comp. | | |
|---|---|---|---|---|---|---|---|
| | Ex. 6 | Ex. M | Ex. N | Ex. O | Ex. P | Ex. 20 | Ex. 21 |
| Polyol 46 | 51.15 | 51.15 | 51.15 | 51.15 | 51.15 | 51.15 | 51.15 |
| Polyol 51 | 5 | 5 | 5 | 5 | 5 | 5 | 5 |
| Glycerol | 4.5 | 4.5 | 4.5 | 4.5 | 4.5 | 4.5 | 4.5 |
| Dipropylene glycol | 0.2 | 0.2 | 0.2 | 0.2 | 0.2 | 0.2 | 0.2 |
| Polyol 26 | | 2.5 | 5 | | | | |
| Polyol 52 | | 2 | | 2 | | | |
| Polyol 25 | | | | 2.5 | | | |
| Polyol 1 | | | | | 5 | | |
| Polyol 12 | | | | | | 5 | |
| Polyol 17 | | | | | | | 5 |
| Flame retardant 1 | 20 | 20 | 20 | 20 | 20 | 20 | 20 |
| Flame retardant 2 | 5 | 5 | 5 | 5 | 5 | 5 | 5 |
| Flame retardant 3 | 12.5 | 12.5 | 12.5 | 12.5 | 12.5 | 12.5 | 12.5 |
| Stabilizer 4 | 1.3 | 1.3 | 0.5 | 0.5 | 0.5 | 0.5 | 0.5 |
| Stabilizer 5 | 0.5 | 0.5 | 0.5 | 0.5 | 0.5 | 0.5 | 0.5 |
| Catalyst 6 | 3.1 | 3.1 | 3.1 | 3.1 | 3.1 | 3.1 | 3.1 |
| Water | 2.55 | 2.55 | 2.55 | 2.55 | 2.55 | 2.55 | 2.55 |
| n-Pentane | 6.0 | 6.0 | 6.0 | 6.0 | 6.0 | 6.0 | 6.0 |
| Phase stability of polyol [23°] | No demixing | Demixed | Demixed | Demixed | Demixed | Demixed | No |
| | after 2 | after 1 hour | after 1 hour | after 1 hour | after 1 hour | after 4 | demixing |
| | weeks | | | | | hours | after 2 |
| | | | | | | | weeks |
| Mixing ratio 100: | 126 | 126 | 126 | 126 | 126 | 126 | 126 |
| Cream time [s] | 17 | 18 | 16 | 17 | 17 | 18 | 19 |
| Fiber time [s] | 45 | 45 | 44 | 46 | 45 | 46 | 45 |
| Foam density [g/l] | 40 | 41 | 41 | 29 | 39 | 41 | 39 |
| Element thickness [mm] | 120 | 120 | 120 | 120 | 120 | 120 | 120 |
| Indentation test [N] | 120 | 180 | 210 | 191 | 201 | 225 | 202 |
| Proportion of open cells [%] | 8 | 10 | 7 | 6 | 9 | 8 | 10 |
| Burning behavior (DIN 4102) | B2 | B2 | B2 | B2 | B2 | B2 | B2 |
| Curing at the end of the belt | 3 | 2 | 1-2 | 2 | 1-2 | 1-2 | 1-2 |
| Frequency of voids | 3 | 2 | 1-2 | 2 | 1-2 | 1-2 | 1-2 |
| Foam structure | 2 | 2 | 2 | 2 | 2 | 2 | 2 |

TABLE 9

| | Comparative | Comparative | Comparative | Comparative | Comparative | | | Comparative |
|---|---|---|---|---|---|---|---|---|
| | Ex. 7 | Ex. Q | Ex. R | Ex. S | Ex. T | Ex. 22 | Ex. 23 | Ex. U |
| Polyol 53 | 31.14 | 31.14 | 31.14 | 31.14 | 31.14 | 31.14 | 31.14 | 31.14 |
| Polyol 22 | 38.47 | 38.47 | 38.47 | 38.47 | 38.47 | 38.47 | 38.47 | 38.47 |
| Polyol 26 | | 2.5 | 5 | | | | | |
| Polyol 52 | | 2 | | 2 | | | | |
| Polyol 25 | | | | 2.5 | | | | |
| Polyol 3 | | | | | 5 | | | |
| Polyol 7 | | | | | | 5 | | |
| Polyol 14 | | | | | | | 5 | |
| Polyol 18 | | | | | | | | 5 |
| Dipropylene glycol | 20.25 | 20.25 | 20.25 | 20.25 | 20.25 | 20.25 | 20.25 | 20.25 |
| Ethylene glycol | 3.3 | 3.3 | 3.3 | 3.3 | 3.3 | 3.3 | 3.3 | 3.3 |
| Stabilizer 6 | 3.12 | 3.12 | 3.12 | 3.62 | 3.12 | 3.12 | 3.12 | 3.12 |
| Catalyst 2 | 0.32 | 0.32 | 0.32 | 0.32 | 0.32 | 0.32 | 0.32 | 0.32 |
| Catalyst 7 | 2.93 | 2.93 | 2.93 | 2.93 | 2.93 | 2.93 | 2.93 | 2.93 |
| Water | 0.47 | 0.47 | 0.47 | 0.47 | 0.47 | 0.47 | 0.47 | 0.47 |
| Cyclopentane | 17 | 17 | 17 | 17 | 17 | 17 | 17 | 17 |
| Phase stability of | No demixing | Demixed | Demixed | Demixed | Demixed | No | No | Demixed |
| polyol [23°] | after 2 weeks | after 1 hour | after 1 hour | after 1 hour | after 1 hour | demixing | demixing | after 1 hour |
| | | | | | | after 2 | after 2 | |
| | | | | | | weeks | weeks | |
| Mixing ratio 100: | 300 | 300 | 300 | 300 | 300 | 300 | 300 | 300 |
| Cream time | 18 | 16 | 17 | 19 | 18 | 18 | 17 | 18 |
| Fiber time | 30 | 28 | 30 | 30 | 29 | 30 | 30 | 28 |
| Foam density | 69 | 68 | 70 | 70 | 69 | 70 | 71 | 69 |
| Element thickness | 80 | 80 | 80 | 80 | 80 | 80 | 80 | 80 |
| [mm] | | | | | | | | |
| Proportion of open | 7 | 6 | 7 | 9 | 5 | 5 | 6 | 7 |
| cells [%] | | | | | | | | |
| Burning behavior | B3 | B3 | B3 | B3 | B3 | B3 | B3 | B3 |
| (DIN 4102) | | | | | | | | |
| Curing at the end | 3 | 2 | 1-2 | 2 | 1-2 | 1-2 | 1-2 | 1-2 |
| of the belt | | | | | | | | |
| Frequency of voids | 3 | 2 | 1-2 | 2 | 1-1 | 1-2 | 1-2 | 1-2 |
| Foam structure | 2 | 2 | 2 | 2 | 2 | 2 | 2 | 2 |

Raw Materials Used:

Macromer 1: monofumarate ester, ε′ (23° C., 1000 Hz)=5.54, in which the second acid group has been reacted with propylene oxide, starting from a polyether alcohol based on glycerol, propylene oxide, ethylene oxide; hydroxyl number of base polyol: 25 mg KOH/g.

Macromer 2: 3-isopropenyl-alpha,alpha-dimethylbenzyl isocyanate (TMI) adduct of a polyether alcohol, ε′ (23° C., 1000 Hz)=5.72, based on sorbitol, propylene oxide, about 15% of ethylene oxide; hydroxyl number of base polyol: 18 mg KOH/g.

Macromer 3: 3-isopropenyl-alpha,alpha-dimethylbenzyl isocyanate (TMI) adduct of a polyether alcohol, ε′ (23° C., 1000 Hz)=5.83, based on sorbitol, propylene oxide, about 20% of ethylene oxide; hydroxyl number of base polyol: 18 mg KOH/g.

Macromer 4: 3-isopropenyl-alpha,alpha-dimethylbenzyl isocyanate (TMI) adduct of a polyether alcohol, ε′ (23° C., 1000 Hz)=7.87, based on glycerol, propylene oxide, about 73% of ethylene oxide; hydroxyl number of base polyol: 42 mg KOH/g.

Macromer 5: 3-isopropenyl-alpha,alpha-dimethylbenzyl isocyanate (TMI) adduct of a polyether alcohol, ε′ (23° C., 1000 Hz)=8.31, based on trimethylolpropane, propylene oxide, about 74% of ethylene oxide, whose isocyanate-reactive hydrogen atoms have been partly reacted with TDI prior to the reaction with TMI; hydroxyl number of base polyol: 24 mg KOH/g.

Macromer 6: 3-isopropenyl-alpha,alpha-dimethylbenzyl isocyanate (TMI) adduct of a polyether alcohol, ε′ (23° C., 1000 Hz)=8.17, based on glycerol, propylene oxide, about 73% of ethylene oxide, whose isocyanate-reactive hydrogen atoms have been partly reacted with TDI prior to the reaction with TMI; hydroxyl number of base polyol: 42 mg KOH/g.

Macromer 7: monofumarate ester, ε′ (23° C., 1000 Hz)=5.64, in which the second acid group has been reacted with propylene oxide, starting from a polyether alcohol based on trimethylolpropane, propylene oxide, ethylene oxide; hydroxyl number of base polyol: 27 mg KOH/g.

Macromer 8: 3-isopropenyl-alpha,alpha-dimethylbenzyl isocyanate (TMI) adduct of a polyether alcohol, ε′ (23° C., 1000 Hz)=5.75, based on sorbitol, propylene oxide, about 25% of ethylene oxide; hydroxyl number of base polyol: 18 mg KOH/g.

Macromer 9: 3-isopropenyl-alpha,alpha-dimethylbenzyl isocyanate (TMI) adduct of a polyether alcohol, ε′ (23° C., 1000 Hz)=5.42, based on sorbitol, propylene oxide, about 22% of ethylene oxide; hydroxyl number of base polyol: 18 mg KOH/g.

Macromer 10: 3-isopropenyl-alpha,alpha-dimethylbenzyl isocyanate (TMI) adduct of a polyester alcohol, ε′ (23° C., 1000 Hz)=7.47, based on adipic acid and ethylene glycol; hydroxyl number of base polyol: 55 mg KOH/g.

Polyol 1: graft polyol having a hydroxyl number of 88 mg KOH/g, a solids content of 45% by weight and a viscosity at 25° C. of 4900 mPa·s, ε′ (23° C., 1000 Hz)=4.89, prepared by in-situ polymerization of acrylonitrile and styrene in a mass ratio of 1:2 in a carrier polyol based on trimethylolpropane, propylene oxide, hydroxyl number: 160 mg KOH/g.

Polyol 2: graft polyol having a hydroxyl number of 88 mg KOH/g, a solids content of 45% by weight and a viscosity at 25° C. of 3800 mPa·s, ε′ (23° C., 1000 Hz)=4.94, prepared by in-situ polymerization of acrylonitrile and styrene in a mass ratio of 1:2 in a carrier polyol based on trimethylolpropane, propylene oxide, hydroxyl number: 160 mg KOH/g.

Polyol 3: graft polyol having a hydroxyl number of 88 mg KOH/g, a solids content of 45% by weight and a viscosity at 25° C. of 3900 mPa·s, ε′ (23° C., 1000 Hz)=5.04, prepared by in-situ polymerization of acrylonitrile and styrene in a mass ratio of 1:2 in a carrier polyol based on trimethylolpropane, propylene oxide, hydroxyl number: 160 mg KOH/g.

Polyol 4: graft polyol having a hydroxyl number of 88 mg KOH/g, a solids content of 45% by weight and a viscosity at 25° C. of 5800 mPa·s, ε′ (23° C., 1000 Hz)=5.41, prepared by in-situ polymerization of acrylonitrile and styrene in a mass ratio of 1:2 in a carrier polyol based on trimethylolpropane, propylene oxide, hydroxyl number: 160 mg KOH/g.

Polyol 5: graft polyol having a hydroxyl number of 88 mg KOH/g, a solids content of 45% by weight and a viscosity at 25° C. of 3600 mPa·s, ε′ (23° C., 1000 Hz)=6.31, prepared by in-situ polymerization of acrylonitrile and styrene in a mass ratio of 1:2 in a carrier polyol based on glycerol, propylene oxide and about 7-8% of ethylene oxide: 160 mg KOH/g.

Polyol 6: graft polyol having a hydroxyl number of 35 mg KOH/g, a solids content of 45% by weight and a viscosity at 25° C. of 3200 mPa·s, ε′ (23° C., 1000 Hz)=6.03, prepared by in-situ polymerization of acrylonitrile and styrene in a mass ratio of 1:2 in a carrier polyol based on dipropylene glycol, propylene oxide and about 25% of ethylene oxide, hydroxyl number: 63 mg KOH/g.

Polyol 7: graft polyol having a hydroxyl number of 23 mg KOH/g, a solids content of 45% by weight and a viscosity at 25° C. of 4900 mPa·s, ε′ (23° C., 1000. Hz)=6.14, prepared by in-situ polymerization of acrylonitrile and styrene in a mass ratio of 1:2 in a carrier polyol based on glycerol, propylene oxide, about 73% of ethylene oxide, hydroxyl number: 42 mg KOH/g.

Polyol 8: polyether alcohol based on trimethylolpropane, propylene oxide, hydroxyl number: 160 mg KOH/g, ε′ (23° C., 1000 Hz)=7.37.

Polyol 9: polyether alcohol based on glycerol, propylene oxide and ethylene oxide, hydroxyl number: 160 mg KOH/g, ε′ (23° C., 1000 Hz)=8.10.

Polyol 10: polyether alcohol based on dipropylene glycol, propylene oxide and ethylene oxide, hydroxyl number: 63 mg KOH/g, ε′ (23° C., 1000 Hz)=9.83.

Polyol 11: polyether alcohol based on glycerol, propylene oxide, ethylene oxide, hydroxyl number: 42 mg KOH/g, ε′ (23° C., 1000 Hz)=8.27.

Polyol 12: graft polyol having a hydroxyl number of 114 mg KOH/g, a solids content of 40% by weight and a viscosity at 25° C. of 30 000 mPa·s, ε′ (23° C., 1000 Hz)=6.89, prepared by in-situ polymerization of acrylonitrile and styrene in a mass ratio of 1:2 in a carrier polyol based on polyethylene glycol, hydroxyl number: 190 mg KOH/g.

Polyol 13: graft polyol having a hydroxyl number of 35 mg KOH/g, a solids content of 35% by weight and a viscosity at 25° C. of 35 000 mPa·s, ε′ (23° C., 1000 Hz)=6.38, prepared by in-situ polymerization of acrylonitrile and styrene in a mass ratio of 1:2 in a carrier polyol based on dipropylene glycol, propylene oxide, ethylene oxide, about 25% of ethylene oxide, hydroxyl number: 63 mg KOH/g.

Polyol 14: graft polyol having a hydroxyl number of 16 mg KOH/g, a solids content of 35% by weight and a viscosity at 25° C. of 5000 mPa·s, ε′ (23° C., 1000 Hz)=6.46, prepared by in-situ polymerization of acrylonitrile and styrene in a mass ratio of 1:2 in a carrier polyol based on trimethylolpropane, propylene oxide, ethylene oxide, about 75% of ethylene oxide, hydroxyl number: 24 mg KOH/g.

Polyol 15: graft polyol having a hydroxyl number of 27 mg KOH/g, a solids content of 35% by weight and a viscosity at 25° C. of 6600 mPa·s, ε′ (23° C., 1000 Hz)=6.40, prepared by in-situ polymerization of acrylonitrile and styrene in a mass ratio of 1:2 in a carrier polyol based on glycerol, propylene oxide, about 73% of ethylene oxide, hydroxyl number: 42 mg KOH/g.

Polyol 16: graft polyol having a hydroxyl number of 27 mg KOH/g, a solids content of 35% by weight and a viscosity at 25° C. of 8900 mPa·s, ε′ (23° C., 1000 Hz)=6.78, prepared by in-situ polymerization of acrylonitrile and styrene in a mass ratio of 1:2 in a carrier polyol based on glycerol, propylene oxide, about 73% of ethylene oxide, hydroxyl number: 42 mg KOH/g.

Polyol 17: graft polyol having a hydroxyl number of 23 mg KOH/g, a solids content of 45% by weight and a viscosity at 25° C. of 40 000 mPa·s, ε′ (23° C., 1000 Hz)=6.59, prepared by in-situ polymerization of acrylonitrile and styrene in a mass ratio of 1:2 in a carrier polyol based on glycerol, propylene oxide, about 73% of ethylene oxide, molecular weight M_{W}=3500 g/mol.

Polyol 18: graft polyol having a hydroxyl number of 14 mg KOH/g, a solids content of 45% by weight and a viscosity at 25° C. of 17 400 mPa·s, ε′ (23° C., 1000 Hz)=6.78, prepared by in-situ polymerization of acrylonitrile and styrene in a mass ratio of 1:2 in a carrier polyol based on sorbitol, propylene oxide, about 10% of ethylene oxide, hydroxyl number: 26 mg KOH/g, ε′ (23° C., 1000 Hz)=4.86.

Polyol 19: graft polyol having a hydroxyl number of 133 mg KOH/g, a solids content of 35% by weight and a viscosity at 25° C. of 2500 mPa·s, ε′ (23° C., 1000 Hz)=5.98, prepared by in-situ polymerization of acrylonitrile and styrene in a mass ratio of 1:2 in a carrier polyol mixture (1:1) based on trimethylolpropane and propylene oxide; hydroxyl number: 160 mg KOH/g, molecular weight M_{W}=1000 g/mol, and based on trimethylolpropane and ethylene oxide, hydroxyl number: 250 mg KOH/g.

Polyol 20: polyethylene glycol, hydroxyl number 190 mg KOH/g, ε′ (23° C., 1000 Hz)=7.06.

Polyol 21: polyether alcohol based on trimethylolpropane, propylene oxide, about 74% of ethylene oxide, hydroxyl number: 24 mg KOH/g, ε′ (23° C., 1000 Hz)=7.15.

Polyol 22: polyether alcohol based on sorbitol, propylene oxide and ethylene oxide, about 10% of ethylene oxide, hydroxyl number: 26 mg KOH/g, ε′ (23° C., 1000 Hz)=7.34.

Polyol 23: polyether alcohol based on trimethylolpropane, propylene oxide, hydroxyl number: 160 mg KOH/g, ε′ (23° C., 1000 Hz)=6.80.

Polyol 24: graft polyol having a hydroxyl number of 28 mg KOH/g, a solids content of 41% by weight and a viscosity at 25° C. of 4500 mPa·s, ε′ (23° C., 1000 Hz)=4.41, prepared by in-situ polymerization of acrylonitrile and styrene in a mass ratio of 1:2 in a carrier polyol based on glycerol, ethylene oxide and propylene oxide, about 11% of ethylene oxide, hydroxyl number: 48 mg KOH/g.

Polyol 25: graft polyol having a hydroxyl number of 19 mg KOH/g, a solids content of 45% by weight and a viscosity at 25° C. of 7300 mpa·s, ε′ (23° C., 1000 Hz)=4.63, prepared by in-situ polymerization of acrylonitrile and styrene in a mass ratio of 1:2 in a carrier polyol based on glycerol and propylene oxide, about 14% of ethylene oxide, hydroxyl number: 35 mg KOH/g.

Polyol 26: graft polyol having a hydroxyl number of 31 mg KOH/g, a solids content of 45% by weight and a viscosity at 25° C. of 4600 mPa·s, ε′ (23° C., 1000 Hz)=4.59, prepared by in-situ polymerization of acrylonitrile and styrene in a mass ratio of 1:2 in a carrier polyol based on glycerol and propylene oxide, about 11% of ethylene oxide; hydroxyl number: 56 mg KOH/g.

Polyol 27: graft polyol having a hydroxyl number of 133 mg KOH/g, a solids content of 35% by weight and a viscosity at 25° C. of 30 000 mPa·s, ε? (23° C., 1000 Hz)=5.89, prepared by in-situ polymerization of acrylonitrile and styrene in a mass ratio of 1:2 in a carrier polyol mixture (1:1) based on trimethylolpropane and propylene oxide; hydroxyl number: 160 mg KOH/g, molecular weight M_{W}=1000 g/mol, and based on trimethylolpropane and ethylene oxide, hydroxyl number: 250 mg KOH/g.

Polyol 28: polyether alcohol based on glycerol, propylene oxide, hydroxyl number: 35 mg KOH/g, ε′ (23° C., 1000 Hz)=12.22.

Polyol 29: polyether alcohol based on glycerol, propylene oxide, hydroxyl number: 56 mg KOH/g, ε′ (23° C., 1000 Hz)=9.87.

Polyol 30: graft polyol having a hydroxyl number of 31 mg KOH/g, a solids content of 44% by weight and a viscosity at 25° C. of 4500 mPa·s, ε′ (23° C., 1000 Hz)=4.48, prepared by in-situ polymerization of acrylonitrile and styrene in a mass ratio of 1:2 in a carrier polyol based on glycerol, propylene oxide, about 14% of ethylene oxide, hydroxyl number: 56 mg KOH/g.

Polyol 40: polyether alcohol based on sorbitol, propylene oxide, hydroxyl number: 500 mg KOH/g.

Polyol 41: polyether alcohol based on sucrose, pentaerythritol, diethylene glycol and propylene oxide, hydroxyl number: 400 mg KOH/g.

Polyol 42: polyether alcohol derived from vicinal toluenediamine, ethylene oxide and propylene oxide, hydroxyl number: 400 mg KOH/g.

Polyol 43: polyether alcohol based on sucrose, glycerol and propylene oxide, hydroxyl number: 450 mg KOH/g.

Polyol 44: polyether alcohol based on trimethylolpropane and propylene oxide, hydroxyl number: 160 mg KOH/g.

Polyol 45: polyether alcohol based on vicinal toluenediamine, ethylene oxide and propylene oxide, hydroxyl number: 160 mg KOH/g

Polyol 46: polyether alcohol based on sucrose, glycerol and propylene oxide, hydroxyl number: 490 mg KOH/g.

Polyol 47: polyether alcohol based on sucrose, diethylene glycol and propylene oxide, hydroxyl number: 440 mg KOH/g.

Polyol 48: polyether alcohol based on propylene glycol and propylene oxide, hydroxyl number: 105 mg KOH/g.

Polyol 49: polyether alcohol based on sorbitol and propylene oxide, hydroxyl number: 340 mg KOH/g.

Polyol 50: polyester alcohol based on industrial dimeric fatty acid, glycerol, hydroxyl number: 400 mg KOH/g.

Polyol 51: polyether alcohol based on ethylenediamine and propylene oxide, hydroxyl number: 770 mg KOH/g.

Polyol 52: polyether alcohol based on propylene glycol and propylene oxide, hydroxyl number: 250 mg KOH/g

Polyol 53: polyester alcohol prepared from adipic acid, phthalic anhydride, oleic acid and 1,1,1-trimethylolpropane, hydroxyl number: 385 mg KOH/g.

Flame retardant 1: trischloropropyl phosphate

Flame retardant 2: diethyl ethanephosphonate

Flame retardant 3: Ixol®) B251, Solvay AG

Stabilizer 1 Tegostab® B8467, Degussa AG

Stabilizer 2: Tegostab®) B8461, Degussa AG

Stabilizer 3: OS340, Bayer AG

Stabilizer 4: Tegostab® B8466, Degussa AG

Stabilizer 5: Dabco® DC5103, Air Products

Stabilizer 6: 1:1 mixture of Tegostab® B8461 and Tegostab® B8409, Degussa AG

Catalyst 1: N,N-dimethylcyclohexylamine

Catalyst 2: Lupragen® N301, BASF Aktiengesellschaft

Catalyst 3: Dabco® T, Air Products

Catalyst 4: Lupragen® N600, BASF Aktiengesellschaft

Catalyst 5: Polycat 5, Air Products

Catalyst 6: KX315, Elastogran GmbH

Catalyst 7: 47% strength solution of potassium acetate in ethylene glycol

Initiator 1: Wako® V 601, Wako Chemicals GmbH

1. A process for producing polyurethane foams by reacting
a) polyisocyanates with
b) compounds having at least two hydrogen atoms which are reactive toward isocyanate groups in the presence of
c) catalysts,
d) blowing agents,
e) if desired, auxiliaries and additives,
wherein the compounds having at least two hydrogen atoms which are reactive toward isocyanate groups comprise at least one polar graft polyol.

2. The process according to claim 1, wherein the graft polyols are used in an amount of up to 100% by weight, based on the component b.

3. The process according to claim 1, wherein the graft polyols are used in an amount of from 0.5 to 70% by weight, in each case based on the component b.

4. The process according to claim 1, wherein the graft polyols have a hydroxyl number in the range from 20 to 200 mg KOH/g.

5. The process according to claim 1, wherein the graft polyols are used in the production of closed-celled rigid polyurethane foams for use in refrigeration appliances in an amount of from 3 to 70% by weight, based on the component b.

6. The process according to claim 1, wherein the graft polyols are used in the production of closed-celled rigid polyurethane foams for use in sandwich elements in an amount of from 0.5 to 35% by weight, based on the component b.

7. The process according to claim 1, wherein the graft polyols are prepared by in-situ polymerization of ethylenically unsaturated monomers in polyether alcohols which have a hydroxyl number in the range from 100 to 800 mg KOH/g and are obtainable by addition of alkylene oxides onto H-functional starter substances selected from the group consisting of polyfunctional alcohols, sugar alcohols, aliphatic amines and aromatic amines.

8. The process according to claim 1, wherein the graft polyols are prepared using polar ethylenically unsaturated macromers.

9. The process according to claim 1, wherein the graft polyols are prepared using polar carrier polyols.

10. The process according to claim 1, wherein the distribution of the graft polyol particles has a maximum in the range from 0.1 μm to 8 μm, preferably from 0.2 to 3 μm.

11. The process according to claim 1, wherein the graft polyols have a clearly separated bimodal particle size of the polymers.

12. A macromer for preparing graft polyols for use in rigid polyurethane foams which has a dielectric constant ε′ of greater than 7.0 at 23° C. and 1000 Hz.

13. A graft polyol which can be prepared by in-situ polymerization of olefinically unsaturated monomers in a carrier polyol in the presence of at least one macromer according to claim 12.

14. A graft polyol which can be prepared by in-situ polymerization of olefinically unsaturated monomers in a carrier polyol in the presence of a macromer, wherein the carrier polyol has a functionality of from 2 to 8, a hydroxyl number in the range from 100 to 800 mg KOH/g and a content of ethylene oxide units in the polyether chain of at least 30% by weight, based on the molecular weight of the polyol.

15. A graft polyol which can be prepared by in-situ polymerization of olefinically unsaturated monomers, in a carrier polyol in the presence of a macromer, wherein the carrier polyol and the macromer are polar.

16. A storage-stable polyol mixture comprising at least one polar graft polyol.
